(19) United States
(12) Patent Application Publication
(10) Pub. No.: US 2012/0166983 A1
(43) Pub. Date: Jun. 28, 2012

(54) INTEGRATED METADATA AND NESTED AUTHORIZATIONS IN A USER INTERFACE FRAMEWORK

(76) Inventors: Hilmar Demant, Karlsdorf (DE); Sebastian Droll, Heidelberg (DE); Joachim Fitzer, Schriesheim (DE); Ioannis Grammatikakis, Maxdorf (DE); Jan Heiler, Walldorf (DE); Juergen Sattler, Wiesloch (DE); Frank Schertel, Mannheim (DE); Markus Viol, Walldorf (DE); Thorsten Weber, Mannheim (DE); Alexander Rauh, Weinheim (DE)

(21) Appl. No.: 12/979,396

(22) Filed: Dec. 28, 2010

(51) Int. Cl. G06F 3/048

(52) U.S. Cl. 715/764

(57) ABSTRACT

Various embodiments of systems and methods for integrated metadata and nested authorizations in a user interface framework are described herein. User interface components metadata and authorization metadata are stored in one integrated entity. The primary user interface application components have authorization metadata and are checked at runtime for accessibility to the user interface application for a given user. The user interface framework ensures the security of the embedded user interface components via nested authorizations using metadata relations. The metadata relations are used for runtime authorization and policy generation. Generic user interface components are aggregated at runtime.

### FIELD

The field generally relates to the software arts, and, more specifically, to methods and systems for integrated metadata and nested authorizations in a user interface framework.

### BACKGROUND

Many Web application frameworks follow the Model View Controller (MVC) architectural pattern to separate the data model with the business logic from the user interface. The MVC pattern modularizes code, promotes code reuse (use of existing software code, or software knowledge, to build new software code), and allows multiple interfaces to be applied. The MVC architecture consists of a model, a view, and a controller. The model part of the MVC pattern is a domain-specific representation of the data upon which the application operates. Domain logic adds meaning to raw data (for example, calculating the totals, taxes, and shipping charges for shopping cart items). When a model changes its state, it notifies its associated views so they can refresh. The view of the MVC pattern renders the model into a form suitable for interaction, typically a user interface element. Multiple views can exist for a single model for different purposes. The controller of the MVC pattern receives input and initiates a response by making calls on model objects. When a Web application user interface framework is built on the MVC architectural pattern approach, high speed development of uniform user interfaces (UIs) is possible.

Generally, a Web application UI framework works with and maintains business data in the user interface components and in parallel maintains every business object, method, and action access manually as a rule directly in a policy stored in a separate storage unit (independent of the UI components metadata). Thus, there are two types of metadata: one type of metadata describing the UI components and another type of metadata describing the authorizations to the business data. The metadata describing the authorizations could be very detailed and stored in a quite large file since the access to each business object from the business data may be described with an authorization rule in the policy. This leads to checking every time the authorization rule for obtaining access to the business object, method, or action. Maintaining two different types of metadata, for UIs and for authorizations, may cause additional maintenance efforts, decreased system performance, and slow response time of the application. Further, this may lead to inconsistencies between the UI components and the authorizations to the business data.

New combinations of UI components (e.g., building a new view from existing UI components) results in a new set of authorization rules, which have to be maintained manually, thus causing additional maintenance effort and inconsistencies. Also, in general metadata relations are not used for policy generation and for runtime adoptions based on authorizations and scoping. The policies are manually maintained. This may lead to inconsistencies, additional maintenance effort, and lack of flexibility.

### SUMMARY

Various embodiments of systems and methods for integrated metadata and nested authorizations in a user interface framework are described herein. In an embodiment, the method includes receiving a selection of a work center via a request and determining one or more workcenter views assigned to the selected work center, wherein a workcenter view is a generic view or an application view. A primary user interface component assigned to the workcenter view is retrieved. The primary user interface component includes authorization metadata. Finally, a dependent user interface component of the user interface application is retrieved, wherein the dependent user interface component is secured with a nested authorization via a metadata relation with the primary user interface component.

In an embodiment, the system includes a processor and a memory in communication with the processor. The memory comprising a work center structure including one or more workcenter views assigned to a user, wherein a workcenter view is an application view or a generic view. Further, the memory includes an integrated entity including a user interface application component metadata and authorization metadata. At least one dependent user interface component is embedded in the user interface application component and secured via nested authorization metadata. Finally, an identity business objects is included that stores workcenter views assignments.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram illustrating an architectural view of a user interface framework as part of an application platform.

FIG. 2 is a block diagram illustrating integrated UI metadata with an authorization policy.

FIG. 3 is a block diagram illustrating view authorization components and policy aggregation.

FIG. 4 is a flow diagram illustrating a method for retrieving a work center and one or more workcenter views assigned to a user.

FIG. 5 is a block diagram illustrating an exemplary process of assigning views to a user and retrieving the assigned views.

FIG. 6 is a block diagram illustrating an exemplary computer system.

### DETAILED DESCRIPTION

Embodiments of techniques for integrated metadata and nested authorizations in a user interface framework are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiment.

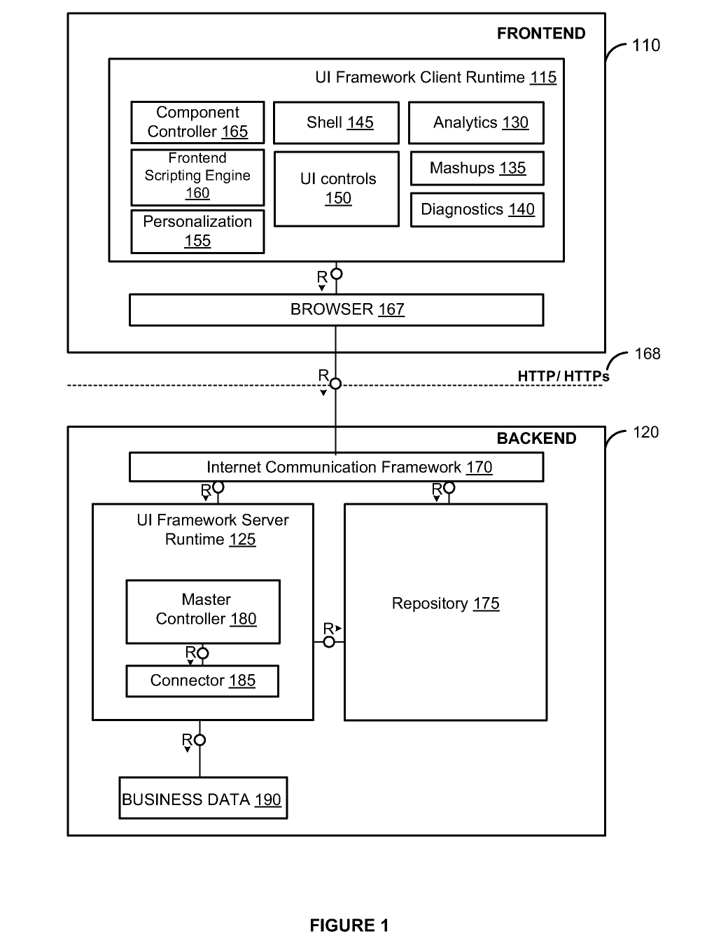

FIG. 1 is a block diagram illustrating an architectural view of a user interface framework as part of an application platform. The application platform is a Web application server including a frontend (client) part 110 and a backend (server) part 120. The UI framework as part of the application platform is responsible for modeling Uls at design time and interpreting them at runtime, so that there is no semantic loss by the generation from one model into another one. The UI framework enables the full separation of UI entities in multiple clients, provides a rendering-engine-independent definition of application Uls and has all the personalization and flexibility features built-in. The UI framework is based on the RIA concept, which removes the need of running Java server in the middle tier for application UI purposes. In this way, the complexity of the Uls is reduced significantly. The UI framework includes a client part—UI Framework Client Runtime 115, and a server part—UI Framework Server Runtime 125.

UI Framework Client Runtime 115 may be implemented in a programming language such as “C# using a RIA based framework such as Microsoft Silverlight® technology. The UI Framework Client Runtime 115 is responsible for rendering user interfaces and access business data from backend 120. Every user request is triggered on the UI Framework Client Runtime 115. The very first request is a navigation request that results in a request to the backend 120 to read a UI component. The UI component is read from the Repository 175 in the backend 120 and transported to the frontend 110. A component manager instantiates the UI component and a corresponding component controller 165 for the UI component on the frontend 110 and triggers the initialization of the UI component on the backend 120. The component manager builds up a control tree for the UI component out of a set of UI controls 150. These UI controls 150 ensure conformable look and feel and the ability to change UI themes consistently. The controls in the “themed UI controls” package are all enabled in a consistent way for test automation and accessibility, and are provided in a manner so that native implemented custom UI panes can make use of those controls. Usually, more than one UI component is needed to render a UI, as UI components typically embed other UI components (e.g., a Work Center component embeds a set of Workcenter View Components and they again embed other components). The top-level UI component that is rendered is the root UI component which makes sure to render a common frame for all UI components, e.g., by rendering the top level navigation and the ability for personalization from personalization unit 155.

In an embodiment, the UI Framework Client Runtime 115 also comprises the following built-in units: analytics 130, mashups 135, diagnostics 140, shell 145, and frontend scripting 160. Analytics 130 are components that represent data in a grouped, aggregated, and hierarchical way. These components serve to answer business questions about, for example, how many products were sold in a particular country and provide drill down capabilities to different level of abstraction. Diagnostics 140 allows the collection of, for example, the context of the current framework and all other running entities of the overall system at a specific point in time (e.g., in case of an exception or error). The collected information can help to track down the cause of the exception. Shell unit 145 provides the shell for running the UI Framework Client Runtime. It includes all units for the user interface ranging from defining the overall appearance of windows (including standard elements such as menus, toolbars, navigation areas, windows management) as well as the mediator layer that maps logical component definitions from the configuration model to physical controls. In addition, there are possibilities to use a Silverlight® feature to run the client in “out of browser” mode. Also, a prototype exists to run the client as a standard WPF desktop client in contrast to the Silverlight® browser plug-in. This requires some replacement of connectivity and authorization code, which is provided by the browser stack itself. Frontend scripting 160 enables data from the client side data model to be read, evaluated, and modified—which causes eventually configured events again in the runtime execution of the model. With these capabilities, UI-only logic can be expressed and modeled via some script; it is not required to implement or model the logic in the backend. Optionally, the script can be executed on the client or backend.

The frontend 110 communicates with the backend 120 via browser 167 on a regular HTTP/HTTPs connection 168 using JavaScript Object Notation (JSON) (also, other serialization formats such as XML can be used in parallel to JSON) as a lightweight data interchange format. The requests from the frontend 110 are received at Internet Communication Framework (ICF) 170. The ICF 170 forwards the requests to the UI Framework Server Runtime 125 and Repository 175. The Repository 175 stores all UI entities with their metadata. The UI Framework Server Runtime 125 reads and interprets the UI model of the application, manages the access to the backend and ensures an optimized communication with the UI Framework Client Runtime 115. After the UI Framework Client Runtime 115 triggers the initialization of a UI component in the backend 120 for a first time in a session, the UI Framework Server Runtime 125 first creates a master controller 180 for the complete session and then creates a component controller for each component that is requested from the UI Framework Client Runtime 115. Each component controller builds a UI data container out of the information of the UI model for a component. At runtime, the composition of the dependent components is combined within the master controller 180, which holds one event queue and performs data updates for all included components as one component. In an embodiment, logically separated declared components can be configured to run as one virtual controller at runtime.

After the master controller 180 has processed all component controllers, it collects all the data that has changed in the UI data container and makes sure that all changed data and only the changed data is transported to the client 110. The access from the UI Framework Server Runtime 125 to business data 190 is performed via connector 185. Connector 185 is able to connect to different technologies.

In various embodiments, there are different types of user interface (UI) entities including, but not limited to: work centers (WoC), workcenter views (e.g., application view, invisible application views, generic views, etc.), UI components, and so on. A work center is a semantic bracket of many workcenter views. A workcenter view is a business cluster of UIs of an application for which a user can be authorized. Work centers are based on application views and generic views. Generic views are user interface views such as “Overview” page in a business application, “reports”, and so on, that provide general information in the business application (aggregated information of application views). Application views are autonomous entities that are built for a special business scenario providing specific features in the business application. The work centers are built from a combination of generic views and application views. Common tasks in a business scenario are defined on view level and are aggregated from the assigned application views to a work center level. Different combinations of the application views can be assigned to a user. In addition, new work centers can be combined based on existing application views. In an embodiment, flexible usage of semantically defined UI entities without duplication the metadata and without combination restrictions is achieved. Further, different permissions to a user are allowed.

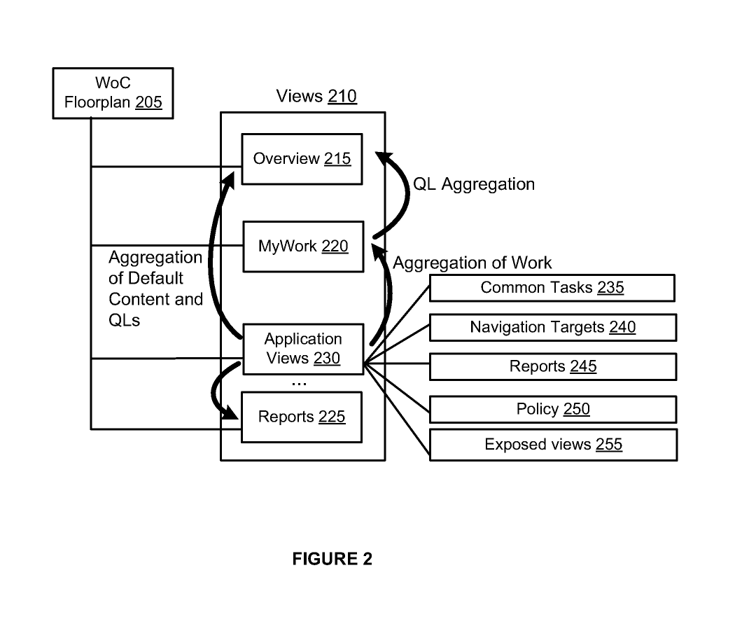

FIG. 2 is a block diagram illustrating integrated UI metadata with an authorization policy. In various embodiments, metadata for a work center and workcenter views is generated at runtime. This allows reuse of the metadata in design time. Based on scoping and access assignments, the correct metadata is obtained. This is particularly valid for navigation targets, reports, BTM tasks, quick links aggregation, and exposed content snippets for the overview page of a work center. The metadata is directly maintained in the UI components. This means that the UI metadata is merged with the authorizations metadata in one metadata maintained in the UI components. Thus providing one integrated environment, where there are no inconsistencies between the UI metadata and authorizations metadata. Also, merging the UI component metadata and authorizations metadata allows the merged metadata to be maintained with a single tool.

In various embodiments, start authorizations are used. This means that at startup of the application, the main UI application component is checked if it can be accessed by the user and all UI components that are embedded (nested) in the main UI application component are running in a privilege mode, meaning that they share the same authorization context with the main UI application component. If the main UI application component is accessible, then the embedded (dependent) UI components in this main UI application component are also accessible. In addition, since only the main UI application component needs authorization, then the metadata for the authorization is maintained only for the main UI application component and no metadata needs to be maintained for the embedded UI components. The UI framework runtime ensures the security of the nested UIs via the metadata relations. The metadata relations are used for authorization aspects during runtime and for policy generation.

FIG. 2 illustrates a work center structure. WoC floorplan 205 represents a work center pattern, a UI model that defines the structure of a work center. Views 210 represent workcenter views, where each view is a separate development entity. The workcenter views 210 consist of generic views such as Overview 215, MyWork 220, and Reports 225, and application views 230. Overview 215 pages have default content such as quick links (QLs). The quick links are shortcuts that navigate to different views. The content of the Overview 215 pages is authorized based on the application views which are assigned to the user. The content is in this case aggregated. In the case of the quick links, object work lists (OWLs) of the views are analyzed and the metadata is used to build the quick link component. MyWork 220 is an additional generic view where a task based information is aggregated. Reports 225 is a standard view for generating and displaying reports. The generic views analyze application views 230 metadata and aggregate (generate) content. Also, the generic components (such as the generic views) have no own authorizations. All authorizations are defined via assigned components using metadata relations. The authority to display the data is covered via the policies of the assigned application views 230 and their assigned entities. The assignment of components (views and work centers) defines which components can be accessed by a given user. The assignment is handled by an identity business object (a storage entity where the user-work center-view assignments are stored), that retrieves the assigned components. In general, the assignment defines which work center floorplans can be accessed and also defines which policies are assigned.

Application views 230 include a set of metadata such as common tasks 235, navigation targets 240, reports 245, policy 250, exposed views 255, and so on. The application views 230 own all relevant metadata and can be reused in other work centers or combined in new work centers. Common tasks 235 metadata is analyzed and aggregated to the work center level (e.g., TaskListView metadata is analyzed and aggregated to the generic view MyWork 220). Object work lists that are integrated in the application views 230 are analyzed and aggregated to quick links UIs that are part of the Overview 215. Reports 245 are analyzed and aggregated to the Reports 225 views. Business tasks are analyzed and are aggregated to MyWork 220 view. Content that can be used for personalization is aggregated to the generic Overview 215. Navigation targets 240 are analyzed and registered in a navigation registry. Authorization rules in policy 250 are analyzed and are aggregated to a policy view. UI framework runtime determines what UIs are allowed for a user based on the aggregated information and displays only them.

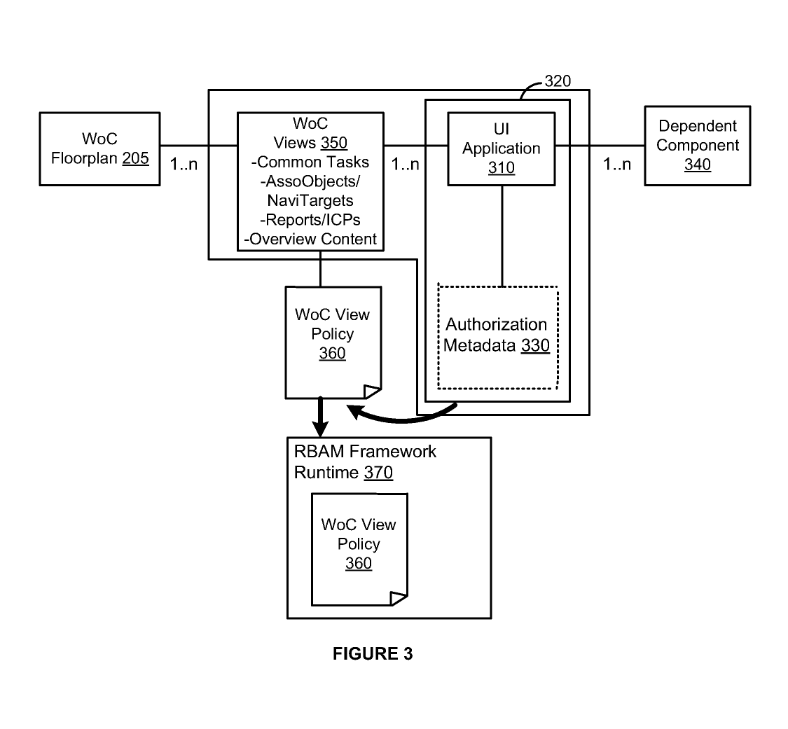

FIG. 3 is a block diagram illustrating view authorization components and policy aggregation. In various embodiments, there may be policies for the following objects: workcenter view and UI components. The policies are part of the UI model, defined together with the UI, since the UI is controlling the authorizations. The authorizations which will be assigned to a user are aggregated on view level based on the embedded and assigned UI components. The overall authorization for a user is combined based on scoping decisions and based on the view assignments to the user. Scoping decisions are made by the user, in which he or she specifies which business functions are in scope of his or her business scenario. Based on these decisions, the policy is updated and allows only the related Uls which are in scope to be displayed to the user.

FIG. 3 includes the following UI components: WoC views 350 and UI Application 310. The UI components are the basis for the view authorization. UI Application 310 is the main UI component for which authorization metadata 330 is assigned. Authorization metadata 330 is maintained and stored together with UI Application 310 component metadata in one integrated entity 320 where only one access rule is maintained for accessing and starting the UI Application 310 component at runtime. UI Application 310 includes one or more embedded dependent components 340 (also UI components) such as reuse components, reports 245, etc. The dependent components 340 are running in the context of the UI Application 310 and are controlled via metadata relations, so the access to the dependent components 340 depends on the access to the UI Application 310. The dependent components 340 do not maintain own authorization data, but inherit authorization access from the UI Application 310. Thus, access to the dependent components 340 is based on nested authorizations. One or more of the UI Application 310 components is assigned to workcenter view 350 as an application view. The workcenter views represent views 210 of FIG. 2. The workcenter views 350 may be assigned to users, so that the user can access them. The user assignments are performed at workcenter view level and are stored in the identity business object. One or more WoC views 350 may be assigned to WoC floorplan 205 representing the structure of a work center. The view authorization is combined based on the UI components: WoC views 350 and UI Application 310. For each UI Application 310, a workcenter view policy 360 can be generated and assigned to a user.

The policy represents a set of rules (per UI Application) that allows the usage of the UI Application and defines which business objects should be checked in addition at runtime. Policies are defined at view level. No policies are generated for generic views, only for application views. A policy for an application view includes the authorization to launch the application view of a work center with the corresponding main UI component and dependent UI components. The policies for the application views are generated at runtime after scoping. Scoping is restricting (based on business decisions) the metadata relations which are used to create the policy. The policy generation can be triggered manually or automatically by the UI framework. The scoping decisions are made by the customer, in which he or she specifies which business functions are in scope of a given business scenario. Based on these decisions, the policy is updated and allows only the related UIs which are in scope to be accessed.

The included authorization metadata in the integrated entity 320, the policies, and the modeled assignments of the UI components are provided to a UI framework such as Role Based Access Management basic (RBAM) framework. The RBAM framework ensures that those BOs are accessed for which the user is authorized. A UI framework runtime such as the RBAM framework runtime 370 checks the UI Application 310 for access authorizations based on the integrated metadata 320.

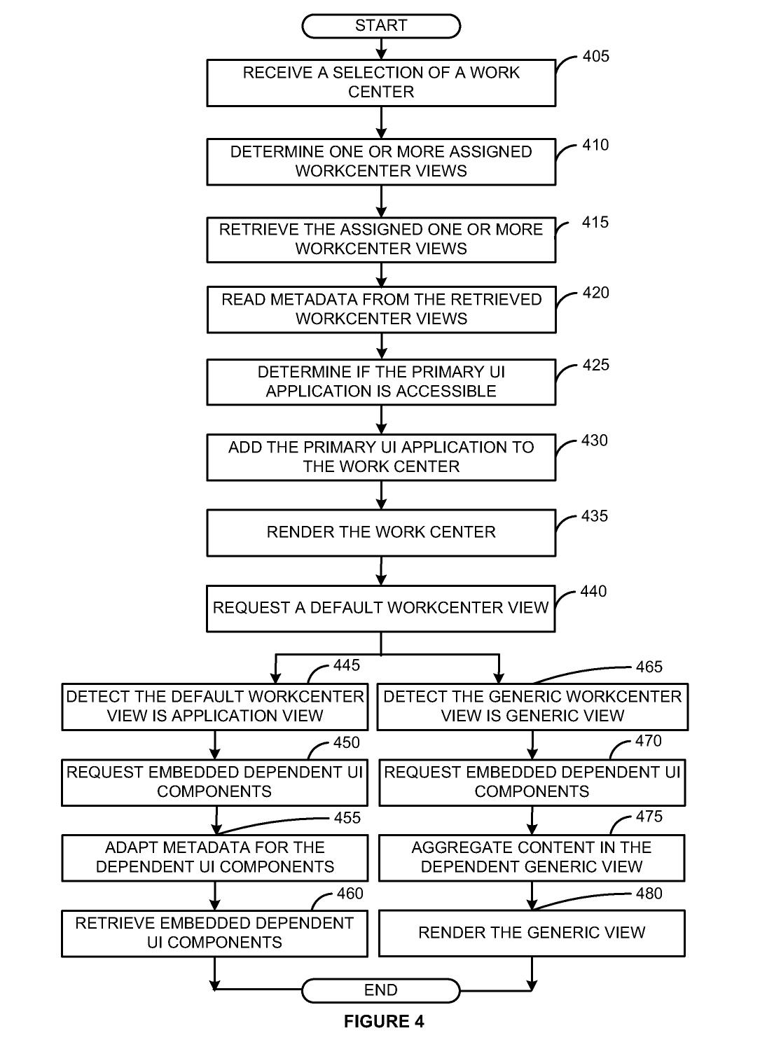

FIG. 4 is a flow diagram illustrating a method for retrieving a work center and one or more workcenter views assigned to a user. At block 405, a selection of a work center is received via a user request. At block 410, it is determined which one or more workcenter views are assigned to the user. At block 415, the determined one or more workcenter views are retrieved. The assignments of work centers and workcenter views to given users are stored in an identity business object. All authorization assignments are manifested as roles on the identity business object, for example, for a user interface a role corresponds to a workcenter view.

The workcenter views may be generic views or application views. In an embodiment, a primary UI application component is assigned to the application view. At block 420, common tasks metadata is read from the retrieved workcenter views. At block 425, it is determined whether the primary UI Application component is accessible based on assigned authorization metadata. The primary UI application component includes assigned authorization metadata. Thus, the authorization metadata is integrated in the main (or primary) UI application component metadata. The main UI application component may include at least one dependent component as no authorization data is assigned to the dependent component. The authorization of the dependent component is based on the assigned authorization metadata to the main UI Application component. The dependent component runs in the access context of the main UI application component. If the user has access rights to the main UI Application component, then the user can access the dependent UI component as well via the nested authorizations. At block 430, if the primary UI Application component is accessible, then the primary UI Application component is added as common tasks to the selected work center. At block 435, the selected work center is rendered. At block 440, a default workcenter view is requested, without a new user request. If the default workcenter view is detected as an application view, the process continues at block 445. Otherwise, the process continues at block 465.

At block 445, the default workcenter view is detected as an application view with an assigned primary UI Application component. The embedded UI application components of the application view are read and the application view is rendered. At block 450, the embedded dependent UI components are requested, without a new user request. At block 455, the metadata of the main UI application component is adapted for the dependent components based on the nested authorizations. The business data of the dependent components is requested based on the assigned authorizations. At block 460, the embedded dependent components are retrieved by requesting them in the context of the primary UI Application component. The requested business data is retrieved and generated in the work center.

At block 465, the default workcenter view is detected as a generic view. At block 470, the embedded default UI components of the generic view are requested for read. Since the generic view has no assigned policy (the authorizations are given by other views), it is determined if the embedded default UI components are authorized. If an embedded default UI component is not authorized, it will be removed. At block 475, exposed content for which the user is authorized (from other views, e.g., application views) is automatically aggregated and added as personalization content in the generic view. At block 480, the generic view is rendered. The embedded UI components (which are not UI application components) are requested. The content of the UI components is aggregated from the authorized views and the relevant content. The corresponding metadata and business data is displayed.

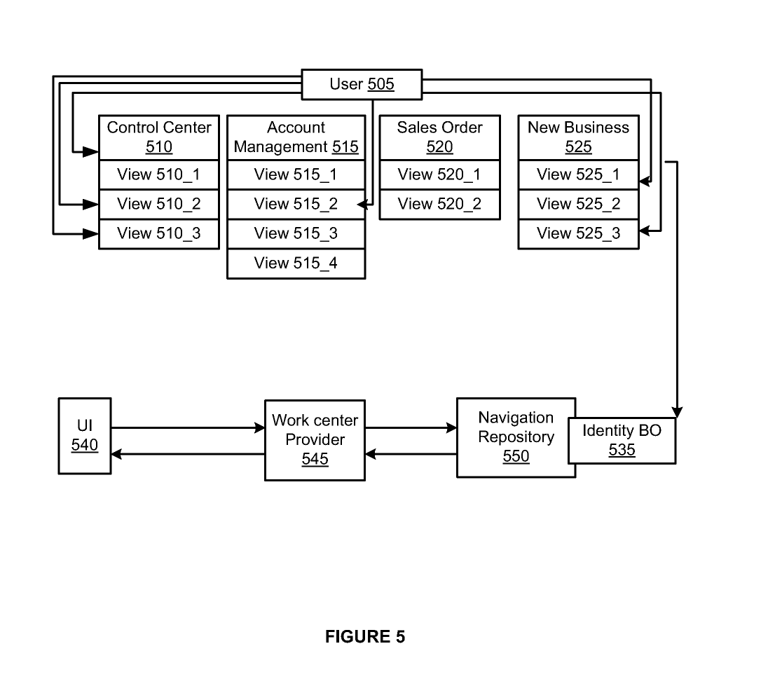

FIG. 5 is a block diagram illustrating an exemplary process of assigning views to a user and retrieving the assigned views. At design time, the assignment of UI components and view authorizations is performed. At run time, one or more workcenter views are assigned to a user. For an application workcenter view, a policy is generated. The policy is assigned to a given user as well, so that, the user is authorized to access the application workcenter views and dependent generic views. For user 505, a set of views from different work centers covering different areas in an application are assigned. Control center 510 is a home work center, which is the first work center displayed to user 505. It is a mandatory work center, where the displayed content and the authorizations are aggregated based on the other assigned work center and workcenter views. Control center 510 includes the following workcenter views: view 510_1, view 510_2, and view 510_3. Account management 515 is an application work center that can be assigned to user 505. Account management 515 work center includes the following views: 515_1, 515_2, 515_3, and 515_4. Sales order 520 work center is also an application work center that can be assigned to user 505. Sales order 520 includes the following workcenter views: 520_1 and 520_2. New business 525 work center is an application work center as well and can be assigned to user 505. New business 525 work center includes the following workcenter views: 525_1, 525_2, and 525_3. In the exemplary scenario, the following workcenter views are assigned to user 505: 510 1, 510 2, 510 3, 515 2, 525 1, and 525_3. No workcenter views from Sales order 520 work center are assigned to user 505. The assignments of the workcenter views to the user 505 are stored in the identity business object 535. For each application view, a policy is generated for the user containing a set of rules that allow the user to access and use the assigned UI application to the application view. The policy is generated in a client system, but not during administration and configuration, when the end user is accessing the system (at runtime). The analysis of the assignments and related policies is performed at runtime. Further, the assignments of the workcenter views to user 505 are based on scoping decisions.

At some point in time, the user 505 decides to start the application to view or edit some data. The application is accessed by entering logon data such as a user name and password in user interface 540. After the logon, the UI 540 forwards the user request to work center provider 545. The work center provider 545 handles (e.g., selects, stores, adapts based on authorizations, scoping, and so on) the work center models at design time and runtime. The work center provider 545 retrieves the related design time metadata from navigation repository 550 and is adapts the metadata based on the authorizations (user-Workcenter-View assignments) and based on the scoping decisions. In an embodiment, navigations are handled as indirect navigations. This means that a target UI is not directly retrieved. Instead, a source UI triggers an abstract navigation (business object and operation, e.g., SalesOrderBO-Open) and the UI framework detects based on the authorizations, scoping, etc., which targets are allowed and what UI is launched.

The assigned work centers (e.g., control center 510, account management 515, and new business 525) and workcenter views (e.g., 510_1, 510_2, 510_3, 515_2, 525_1, and 525_3) are retrieved from the navigation repository 550 based on the identity business object and scoping decisions and sent to the work center provider 545. The work center provider 545 forwards the assigned WoCs and WoC views to the UI 540. The UI 540 displays the assigned WoCs and WoC views to user 505 based on the user authorizations and the scoping decisions.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

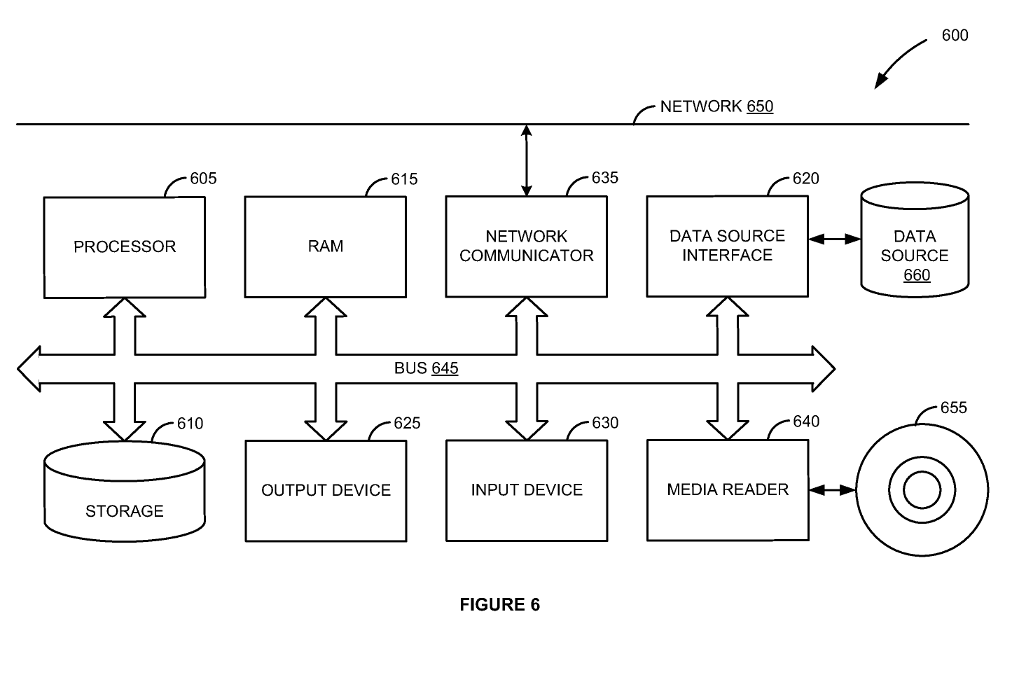

FIG. 6 is a block diagram illustrating an exemplary computer system 600. The computer system 600 includes a processor 605 that executes software instructions or code stored on a computer readable storage medium 655 to perform the above-illustrated methods of the invention. The computer system 600 includes a media reader 640 to read the instructions from the computer readable storage medium 655 and store the instructions in storage 610 or in random access memory (RAM) 615. The storage 610 provides a large space for keeping static data where at least some instructions could be stored for later execution. The stored instructions may be further compiled to generate other representations of the instructions and dynamically stored in the RAM 615. The processor 605 reads instructions from the RAM 615 and performs actions as instructed. According to one embodiment of the invention, the computer system 600 further includes an output device 625 (e.g., a display) to provide at least some of the results of the execution as output including, but not limited to, visual information to users and an input device 630 to provide a user or another device with means for entering data and/or otherwise interact with the computer system 600. Each of these output 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be access via one or more abstraction layers implemented in hardware or software. For example, the data source 660 may be access by network 650. In some embodiments the data source 660 may be accessed via an abstraction layer, such as, a semantic layer.

A data source 660 is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a tangible computer readable storage medium to physically store instructions, which when executed by a computer, cause the computer to:
receive a selection of a work center via a request;
determine one or more workcenter views assigned to the selected work center, wherein a workcenter view is a generic view or an application view;
retrieve a primary user interface component assigned to the workcenter view, wherein the primary user interface component includes authorization metadata; and
retrieve a dependent user interface component of a user interface application, wherein the dependent user interface component is secured with a nested authorization via a metadata relation with the primary user interface component.

2. The article of manufacture of claim 1, wherein the instructions further cause the computer to:
retrieve the assigned one or more workcenter views; and
display the work center and the one or more workcenter views assigned to the work center in a user interface.

3. The article of manufacture of claim 1, wherein the primary user interface component is assigned to the application view.

4. The article of manufacture of claim 1, wherein a policy is assigned to the application view, the policy includes a rule that allows access to the application view based on the authorization metadata and scoping decisions.

5. The article of manufacture of claim 1, wherein the authorization metadata and the primary user interface component metadata are integrated into one entity.

6. The article of manufacture of claim 1, wherein the instructions further cause the computer to generate the generic view based on the dependent user interface component.

7. The article of manufacture of claim 2, wherein the work center and the one or more workcenter views are retrieved via an identity business object.

8. A computerized method comprising:
receiving a selection of a work center via a request;
determining one or more workcenter views assigned to the selected work center, wherein a workcenter view is a generic view or an application view;
retrieving a primary user interface component assigned to the workcenter view, wherein the primary user interface component includes authorization metadata; and
retrieving a dependent user interface component of a user interface application, wherein the dependent user interface component is secured with a nested authorization via a metadata relation with the primary user interface component

9. The method of claim 8, further comprising:
retrieving the work center and the assigned one or more workcenter views; and
displaying the work center and the one or more workcenter views assigned to the work center in a user interface.

10. The method of claim 8, wherein the primary user interface component is assigned to the application view.

11. The method of claim 8, wherein a policy is assigned to the application view, the policy includes a rule that allows access to the application view based on the authorization metadata and scoping decisions.

12. The method of claim 8, wherein the authorization metadata and the primary user interface component metadata are integrated into one entity.

13. The method of claim 8, wherein the instructions further cause the computer to generate the generic view based on the dependent user interface component.

14. The method of claim 9, wherein the work center and the one or more workcenter views are retrieved via an identity business object.

15. A computing system comprising:
a processor; and
a memory in communication with the processor, the memory comprising:
a work center structure including one or more workcenter views assigned to a user, wherein a workcenter view is an application view or a generic view;
an integrated entity including a primary user interface application component metadata and authorization metadata;
at least one dependent user interface component embedded in the user interface application component and secured via nested authorization metadata; and
an identity business objects that stores workcenter views assignments.

16. The computing system of claim 15, further comprising:
a user interface to display the work center structure including the one or more workcenter views assigned to the user.

17. The computing system of claim 15, further comprising:
a policy assigned to the application view, wherein the policy includes a rule that allows access to the application view based on the authorization metadata and scoping decisions.

18. The computing system of claim 15, wherein the primary user interface application component is assigned to the application view.

19. The computing system of claim 15, wherein the generic view is generated by aggregating metadata from the dependent user interface component.

20. The computing system of claim 15, further comprising a role based access management runtime that checks the user interface application component for access authorizations for the user via the integrated entity.
